(19) United States
(12) Patent Application Publication
(10) Pub. No.: US 2013/0016390 A1
(43) Pub. Date: Jan. 17, 2013

(54) DOCUMENT TRANSMISSION SYSTEM AND METHOD

(71) Applicant: Chen-Ning Hsi, Taipei City (TW)

(72) Inventor: Chen-Ning Hsi, Taipei City (TW)

(21) Appl. No.: 13/351,230

(22) Filed: Jan. 17, 2012

Related U.S. Application Data
(63) Continuation-in-part of application No. 12/198,856, filed on Aug. 26, 2008, now abandoned.

(51) Int. Cl. H04N 1/00; G06K 15/02

(52) U.S. Cl. 358/1.15; 358/402

(57) ABSTRACT

A document transmission system, which includes a document provider, a document receiver, a storage device, an identifying device, and a transmission system. The document provider is utilized for providing a document having a symbol, which is visually identifiable. The document receiver is utilized for receiving the document, wherein the document receiver has an address. The storage device is configured for storing an address book that that includes the address relevant to the symbol. The identifying device is utilized for identifying the symbol and for mapping the symbol to the address book to obtain the address referring to the symbol. The transmission system is utilized for transmitting the document from the document provider to the document receiver according to the address.

### CROSS REFERENCE TO RELATED APPLICATIONS

This application is a continuation in part application of applicant's earlier application, Ser. No. 12/198,856, filed Aug. 26, 2008, and is included herein by reference.

### BACKGROUND OF THE INVENTION

1. Field of the Invention

The present invention relates to a document transmission system and method, and particularly relates to a document transmission system and method utilizing a network transmission system and a symbol to transmit a document.

2. Description of the Prior Art

A conventional facsimile (fax) machine is connected to a telephone network, and transmits a document to a target receiver such as a printer or another facsimile machine via the telephone network. In this case, a telephone number of the target receiver must be dialed before faxing the document, and therefore, a user must prepare the telephone number and further make sure that the telephone number is correct before faxing the document. The necessity of these steps causes some inconvenience to a user. Furthermore, a facsimile machine needs a telephone network, which is also inconvenient.

Or, the document in the computer can be transmitted in the electronic file form, via the connection between the computer and the fax machine. However, it is inconvenient for the user since the concept to be transmitted must be transformed to the electronic file first. In normal life, there are still many situations that the document needs to be transmitted in a non-electronic file form. For example, if the concepts to be transmitted are printed on a paper, the user needs a transforming machine such as a scanner to transform the paper to the electronic file first before faxing the document. Such operation may cause inconvenience to the user. Besides, such operation is especially inconvenient for the user who is unfamiliar with a computer, since the connection and the fax machine must be established first.

### SUMMARY OF THE INVENTION

Therefore, one objective of the present invention is to provide a convenient document transmitting system (i.e. a fax system), which can transmit a document to a target receiver according to a symbol on the document instead of a telephone number, a fax number or an printer address.

Besides, another objective of the present invention is to provide an intuitive document fax system, which can be utilized to a fax system for multiple users. Such fax system can transmit the symbol on a paper document, and at least one of the user identifying code and a machine identifying code of the faxing device to be identified. By this way, the paper document can be transmitted to the correct document receiver for the correct receiver.

One embodiment of the present invention provides a document transmission system, which includes a document provider, a document receiver, a storage device, an identifying device, and a transmission system. The document provider is utilized for providing a document having a symbol, which is visually identifiable. The document receiver is utilized for receiving the document, wherein the document receiver has an address. The storage device is configured to store an address book that is related to the symbol mapping to the address. The identifying device is utilized for identifying the symbol and for mapping the symbol with the address book to obtain the address referring to the symbol . The transmission system is utilized for transmitting the document from the document provider to the document receiver according to the address.

Another embodiment of the present invention provides a document transmission method, which corresponds to the above-mentioned document transmission system. The method includes (a) utilizing a document provider to provide a document having a symbol, which is visually identifiable, wherein the symbol and the document are recorded on a single paper; (b) utilizing an identifying device to identify the symbol and map the symbol to an address book to obtain an address; and (c) transmitting the document to a document receiver according to the address.

In one preferred embodiment, the identifying device includes a optical characteristic reorganization (OCR) device.

In one preferred embodiment, the document provider is equipped with the identifying device and the storage device.

In one preferred embodiment, the document provider or the document receiver is one of a facsimile machine, a scanner and a multifunction machine.

In one preferred embodiment, the document provider further provides a provider identifying code corresponding to the address book, where, further with reference to the provider identifying code, the identifying device maps the symbol to the address book to obtain the address.

In one preferred embodiment, the document receiver automatically prints out the document when the document receiver receives the document

In one preferred embodiment, the document provider further provides a user identifying code corresponding to the address book, where, further with reference to the user identifying code, the identifying device maps the symbol to the address book to obtain the address.

In one preferred embodiment, wherein the transmission system is a network transmission system coupled to the document provider and the document receiver, and is configured for respectively providing network addresses to the document provider and the document receiver, and for transmitting the document from the document provider to the document receiver

In one preferred embodiment, the network transmission system is Internet or Intranet.

In one preferred embodiment, the document provider and the document receiver both include a document transmission protocol program.

In one preferred embodiment, the network transmission system includes a document transmission protocol program.

In one preferred embodiment, further comprises a server, coupled to the network transmission system, for buffering the document when the document receiver cannot receive the document, wherein the server is equipped with the identifying device and the storage device.

According to the above mentioned embodiments, a user can easily fax a document via a simple symbol instead of dialing a telephone number, and thereby the convenience of utilizing the fax machine is considerably increased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a document transmission system according to a preferred embodiment of the present invention.

FIG. 2 is a schematic diagram illustrating a detailed description of a document transmission system according to a preferred embodiment of the present invention.

FIG. 3 is a schematic diagram illustrating how to use a symbol included in a document in order to transmit the document.

FIG. 4 is a flow chart illustrating a document transmission method according to a first embodiment of the present invention.

FIG. 5 is a flow chart illustrating a document transmission method according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

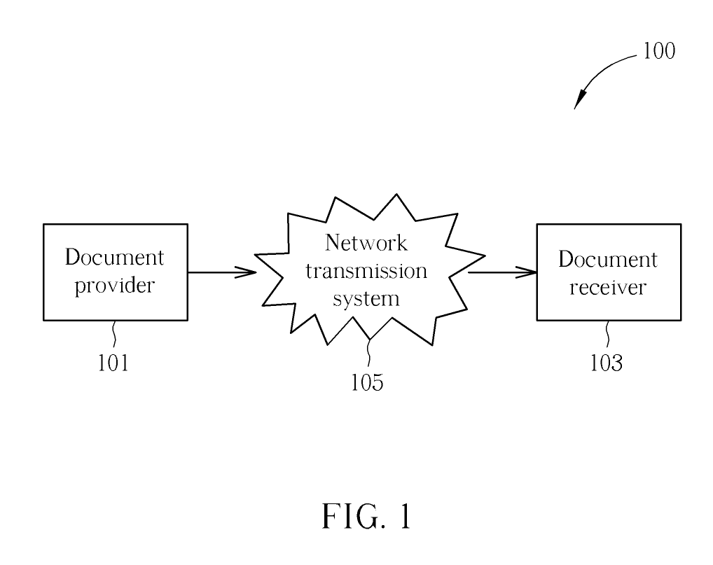

FIG. 1 is a block diagram illustrating a document transmission system 100 according to a preferred embodiment of the present invention. As shown in FIG. 1, the document transmission system 100 includes a document provider 101, a document receiver 103 and a network transmission system 117. The document provider 101 is utilized for providing a document. The document receiver 103 is utilized for receiving the document. The network transmission system 105 (for example, an IP transmission system) is utilized for respectively providing network addresses (e.g. an IP address) to the document provider 101 and the document receiver 103, and for transmitting the document from the document provider 101 to the document receiver 103 according to the network addresses. Compared with the prior art, the present invention provides a document transmission system that utilizes a network transmission system instead of a telephone system.

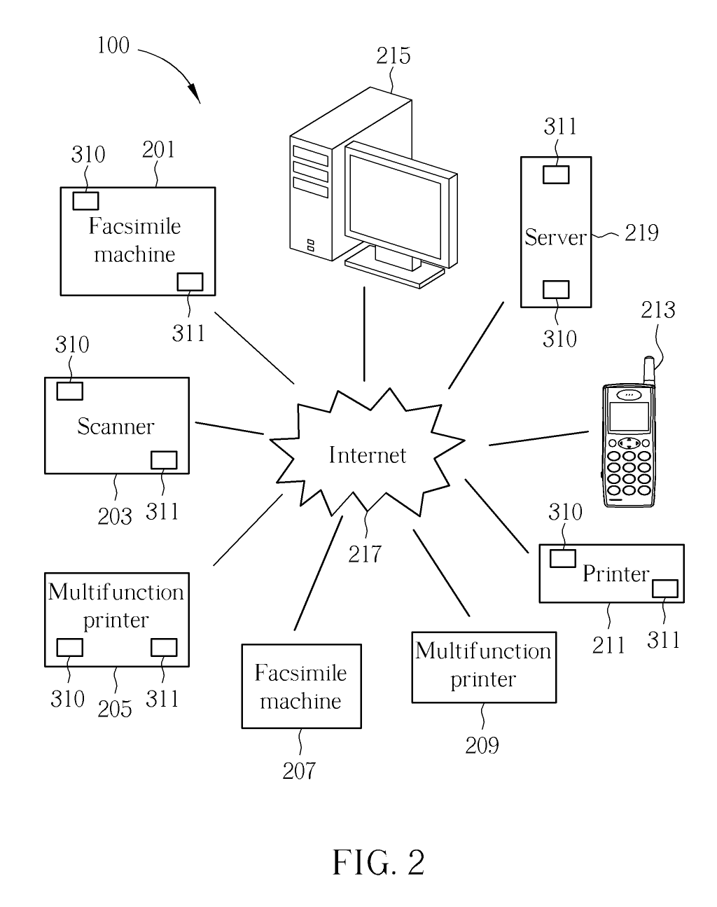

FIG. 2 is a schematic diagram illustrating a detailed description of a document transmission system according to a preferred embodiment of the present invention. Please jointly refer to FIG. 1 and FIG. 2 to understand the concept of the present invention more clearly. As shown in FIG. 2, the document provider 101 shown in FIG. 1 can be a facsimile machine 201, a scanner 203 or a multifunction printer 205; the document receiver 103 shown in FIG. 1 can be a facsimile machine 207, a multifunction printer 209, a printer 211, a mobile phone 213 or a computer 215; and the network transmission system 105 can be Internet 217 (or Intranet). The document provider 101 can receive data printed on a paper to provide the document, and the document receiver 103 can automatically print out the document when the document receiver 103 receives the document, if the document receiver 103 is the facsimile machine 207, the multifunction printer 209, the printer 211 or a similar apparatus.

As shown in FIG. 2, the document transmission system 100 can further include a server 219, for buffering the document when the document provider 101 sends the document but the document receiver 103 is unable to immediately receive the document.

If the document transmission system 100 utilizes a “point to point” mechanism to transmit the document from the document provider 101 to the document receiver 103, the document provider 101 and the document receiver 103 must have document transmission protocol programs (e.g. fax protocol programs) themselves. Also, if the document transmission system 100 utilizes a “routing” mechanism to transmit the document from the document provider 101 to the document receiver 103, the document transmission protocol program can be included in the network transmission protocol program provided for the network transmission system 105.

The first case is, the user wants to transmit the concepts hand-written or printed on the paper to a receiver, but forgets or doesn't exactly write the right fax number, the printer address or the multifunction machine address while transmitting the concepts. In this case, the present invention provides an intuitive document transmission system, which provides at least one address book in the storage device. The address book corresponds to a user, and the concepts of the address book includes at least one address relevant to the identifying symbol and corresponding to the receiver. For example, a fax number, a printer address or a multifunction machine address. It should be noted that the address book may be stored to other devices including storage space besides an independent storage device, such as the identifying device or the server.

The identifying symbol for a receiver can be the symbols or texts indicating the relation between the user and the receiver. For example, father/son/daughter, mother/son/daughter, abbreviated name/nick name for the receiver, name of the identification card for the receiver, or names for the user in other languages. Also, the identifying symbol for a receiver is a symbol that the user can understand who is the receiver when the user see it, rather than a symbol that must be identified by a machine such barcodes. One advantage for above-mentioned mechanism is the user can use a convenient tool at any time. For example, a user can directly utilize a normal pen to write the symbol to the paper document, and does not need to record the concepts on the papers without machine bar codes or other carriers. Additionally, the user can easily check if the receiver is the correct one via simply taking a look at the symbol. That is, such a symbol is visually identifiable. By this way, it can be avoided that the user remember a wrong phone number or dial a wrong phone number. Besides, such symbol can be easily identified for both the user and the machine. Therefore, a normal text identifying system can sufficiently identify concepts of the identifying symbol, no high cost or complicated decoding mechanism or equipments are needed. Also, the user can write names, nicknames or titles for multiple receivers, thus concepts of the document can be transmitted to multiple receivers via only one time of transmitting.

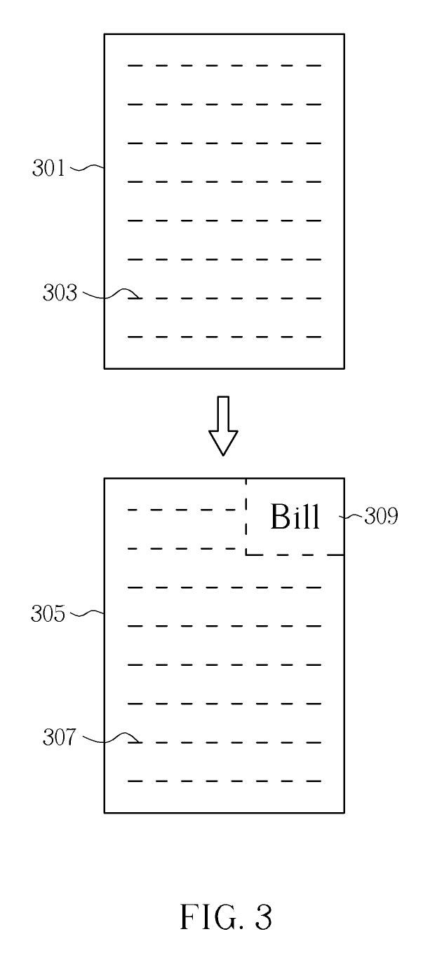

As well as the above-mentioned system, the present invention further provides an easy document transmission method to transmit a document through the above-mentioned systems via only a symbol included in the document. The operations for dialing telephone numbers, remembering fax numbers, or selecting addresses for the printer or the multifunction machine are unnecessary. FIG. 3 is a schematic diagram illustrating how to use a symbol included in a document to transmit the document. As shown in FIG. 3, a conventional document 301 includes only a document concept 303, and a telephone number must be obtained and dialed when the conventional document 301 is to be transmitted via a facsimile machine. A document 305 provided by one embodiment of the present invention, however, includes not only document concept 307 but also a symbol region 309 having a symbol. The document concept 307, which can include (but not limit) printed or hand-written texts, diagrams or graphics, is the concept that the user wants to transmit to a document receiving terminal or a receiver for the document receiver. The symbol region 309 is a symbol corresponding to an identifying symbol for the receiver in the address book. An address of the document receiver 103 can be pre-stored in a storage device 310, which means the address corresponding to the receiver in the address book. The address is in the address book stored in the storage device 310. After that, the address is read according to the symbol in the symbol region 309, which can be identified by an identifying device 311. Preferably, the symbol region 309 is at a fixed location of the document, but does not mean to limit the scope of the present application. More than one regions of the document can be randomly set as the symbol region 309.

In one embodiment, at least one document receiver address is included in an address book, which can reside at least one of the document provider 101, the identifying device 310, and the server 219, and the symbol can be identified and then mapped to an address included in the address book via the identifying device 310. Then the document is transmitted according to the mapped address.

As in the example shown in FIG. 3, if the document 305 is to be faxed to a recipient named Bill, then a word “Bill” can be written on the symbol region 309. “Bill” is one example of the above-mentioned symbol, which can correspond to a receiver named “Bill” and a corresponding address thereof in the address book. Also, the identifying device 310 identifies, recognizes the symbol and maps the symbol to the address book to find a receiver conforms “Bill” and find the address of Bill's facsimile machine. By this way, the address of a facsimile machine corresponding to Bill is obtained and the document can be transmitted accordingly to the document receiver. Such a document can be acquired via directly writing on a paper document and then scanned. Alternatively, the paper document can be scanned first and the symbol can be written on the symbol region 309 via a writing board or similar apparatus. The symbol for obtaining address can be any figure, number or word.

The identifying device 310 can be an optical characteristic reorganization (OCR) device, such as a web camera. In this case, the identifying device 310 can further include other devices besides the optical characteristic reorganization device for the mapping function. Further more, the identifying device 310 can further include a program and perform the mapping function via the control circuit of the optical characteristic reorganization device or other devices. Please refer to FIG. 2 again. One of the storage device 310 and the identifying device 311 can be provided in the facsimile machine 201, the scanner 203 or the multifunction printer 205. Alternatively, one of the storage device 310 and the identifying device 311 can be provided in the server 219.

It should be noted that, although the document transmission method shown in FIG. 3 utilizes the document transmission system shown in FIG. 2 in one example, the method shown in FIG. 3 is not limited to a network transmission system. It can also be utilized in a telephone system. In this case the address of the document receiver is preferably stored in the document provider.

Please note that the address book can also be stored in the server 219. The second case besides the above-mentioned first case is, the server 219 further includes a plurality of address books corresponding to different users. In this case, the system according to the present invention can transmit an identifying code of the document provider 101 (provider identifying code) to the server 219. The address book corresponding to a specific identifying code can found based on the provider identifying code, and then a transmitting address of a specific receiver in the address book can be found accordingly.

Additionally, the third case is, the document provider has a mechanism that different users can utilize passwords thereof to log in the document provider 101 and use it. In this case, the system of the present application can transmit the information corresponding to the user and the symbol (user identifying code) to the storage device 310, to accordingly find correct receiver address in the correct address book. For example, the users A, B respectively utilizes pass words thereof to log in the document provider 101 at different timing, and transmits a document by faxing. The users A, B both utilizes “Bill” as the symbol, that is, the document should be transmitted to the addresses for different “Bill”s, for users A and B. The system of the present invention, can transmit information corresponding to users A and B such as the log in passwords, or the user names corresponding to passwords, and the symbol, to the storage device. After that, the document receiver address of “Bill”s for the users A and B can be accordingly found.

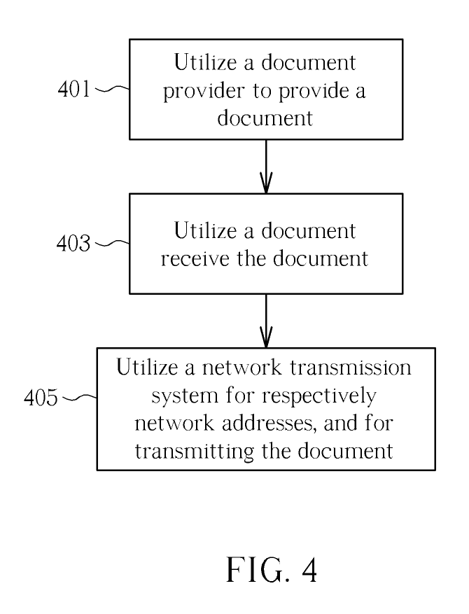

FIG. 4 is a flow chart illustrating a document transmission method according to a first embodiment of the present invention, which corresponds to the embodiment shown in FIG. 2. The document transmission method includes the following steps:

Step 401: Utilize a document provider to provide a document, wherein a visually identifiable symbol is on the document and the document is recorded on a paper.

Step 403: Utilize a document receiver to receive the document.

Step 405: Utilize a network transmission system for respectively providing network addresses to the document provider and the document receiver, and for transmitting the document from the document provider to the document receiver according to the network addresses.

Other detailed characteristics are already illustrated in the above-mentioned embodiments, and are therefore omitted here for brevity.

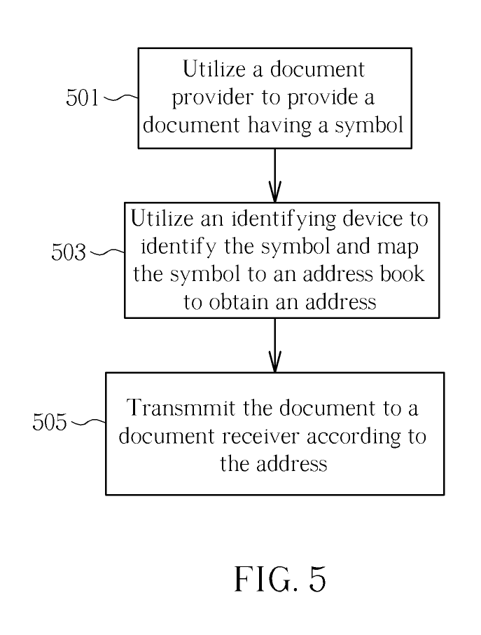

FIG. 5 is a flow chart illustrating a document transmission method according to a second embodiment of the present invention, which corresponds to the embodiment shown in FIG. 3. The document transmission method includes the following steps:

Step 501: Utilize a document provider to provide a document having a symbol, wherein the symbol is visually identifiable on the document and the document is recorded on a paper.

Step 503: Utilize an identifying device to identify the symbol and map the symbol to an address book to obtain an address, wherein the address relevant to the symbol is stored in the address book.

Step 505: Transmit the document to a document receiver according to the address.

Other detailed characteristics are already illustrated in the above-mentioned embodiments, and therefore are omitted here for brevity.

According to the above mentioned embodiments, a user can easily fax the document via a simple symbol instead of dialing a telephone number, significantly increasing the convenience of faxing documents. Also, the utilization of the network address system increases the application of the document transmission system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A document transmission system, comprising:
a document provider, for providing a document having a symbol, wherein the symbol is visually identifiable;
a document receiver, for receiving the document, wherein the document receiver has an address;
a storage device, for storing an address book, wherein the address book comprises the address relevant to the symbol;
an identifying device, coupled to the document provider, for identifying the symbol and for mapping the symbol to the address book to obtain the address with reference to the symbol; and
a transmission system, coupled to the document receiver, the document provider and the identifying device, for transmitting the document from the document provider to the document receiver according to the address.

2. The document transmission system of claim 1, wherein the identifying device includes an optical characteristic reorganization (OCR) device.

3. The document transmission system of claim 1, wherein the identifying device and the storage device are provided in the document provider.

4. The document transmission system of claim 1, wherein the document provider or the document receiver is one of a facsimile machine, a scanner and a multifunction machine.

5. The document transmission system of claim 1, wherein the document provider further provides a provider identifying code corresponding to the address book, and the identifying device, further with reference to the provider identifying code, maps the symbol to the address book to obtain the address.

6. The document transmission system of claim 1, wherein the document receiver automatically prints out the document when the document receiver receives the document.

7. The document transmission system of claim 1, wherein the document provider further provides a user identifying code corresponding to the address book, and the identifying device, further with reference to the user identifying code, maps the symbol to the address book to obtain the address.

8. The document transmission system of claim 1, wherein the transmission system is a network transmission system, coupled to the document provider and the document receiver, for respectively providing network addresses to the document provider and the document receiver, and for transmitting the document from the document provider to the document receiver.

9. The document transmission system of claim 8, wherein the network transmission system is Internet or Intranet.

10. The document transmission system of claim 8, wherein the document provider and the document receiver both include a document transmission protocol program.

11. The document transmission system of claim 8, wherein the network transmission system includes a document transmission protocol program.

12. The document transmission system of claim 1, further comprising a server, coupled to the network transmission system, for buffering the document when the document receiver cannot receive the document, wherein the identifying device and the storage device are provided in the server.

13. A document transmission method, comprising:
(a) utilizing a document provider to provide a document having a symbol, wherein the symbol is visually identifiable and the document is recorded on a single paper;
(b) utilizing an identifying device to identify the symbol and map the symbol to an address book to obtain an address; and
(c) transmitting the document to a document receiver according to the address.

14. The document transmission method of claim 13, wherein the step (b) utilizes an optical characteristic reorganization (OCR) device to identify the symbol.

15. The document transmission method of claim 13, wherein the identifying device is provided in the document provider, and the address book resides in the document provider.

16. The document transmission method of claim 13, wherein the step (a) further comprises providing a provider identifying code corresponding the address book, where the step (b) further comprises mapping the symbol to the address book to obtain the address, with reference to the provider identifying code.

17. The document transmission method of claim 13, wherein the document provider is one of a facsimile machine, a scanner and a multifunction machine.

18. The document transmission method of claim 13, wherein the step (a) further comprises providing a user identifying code corresponding the address book, where the step (b) further comprises mapping the symbol to the address book to obtain the address, with reference to the user identifying code.

19. The document transmission method of claim 13, wherein the document receiver is one of a facsimile machine, a printer and a multifunction machine, where the document receiver automatically prints the document.

20. The document transmission method of claim 13, wherein the step (c) utilizes a network transmission system for respectively providing network addresses to the document provider and the document receiver, and for transmitting the document from the document provider to the document receiver according to the address.

21. The document transmission method of claim 20, wherein the network transmission system is Internet or Intranet.

22. The document transmission method of claim 20, wherein the document provider and the document receiver both include a document transmission protocol program.

23. The document transmission method of claim 20, wherein the network transmission system includes a document transmission protocol program.

24. The document transmission method of claim 20, further comprising utilizing a server for buffering the document when the document receiver can not receive the document.
